(19) United States
(12) Patent Application Publication
(10) Pub. No.: US 2022/0065731 A1
(43) Pub. Date: Mar. 3, 2022

(54) EVAPORATED FUEL PROCESSING DEVICE

(71) Applicant: AISAN KOGYO KABUSHIKI KAISHA, Obu-shi (JP)

(72) Inventor: Yoshikazu Miyabe, Obu-shi (JP)

(21) Appl. No.: 17/401,529

(22) Filed: Aug. 13, 2021

(30) Foreign Application Priority Data
Sep. 1, 2020 (JP) 2020-146771

(51) Int. Cl. G01M 3/28; B60K 15/035

(52) U.S. Cl. CPC G01M 3/2876; B60K 2015/0321; B60K 15/03519

(57) ABSTRACT

When a closing valve is in a closed state, a controller may determine presence of leakage from the closing valve based on: a pressure detected by a first pressure sensor and/or a pressure detected by a second pressure sensor detected when a difference between a pressure in the vapor passage upstream of the closing valve and a pressure in the vapor passage downstream of the closing valve is a first difference; and the pressure detected by the first pressure sensor and/or the pressure detected by the second pressure sensor detected when the difference is a second difference different from the first difference.

### CROSS-REFERENCE TO RELATED APPLICATION

This application claims priority to Japanese Patent Application No. 2020-146771, filed on Sep. 1, 2020, the entire contents of which are incorporated herein by reference.

### TECHNICAL FIELD

The art disclosed herein relates to an evaporated fuel processing device.

### BACKGROUND

Japanese Patent Application Publication No. 2013-185528 (Patent Document 1) describes an evaporated fuel processing device. The evaporated fuel processing device of Patent Document 1 includes a fuel tank, a vapor passage through which evaporated fuel generated from fuel in the fuel tank flows, a closing valve configured to open and close the vapor passage, and a canister in which the evaporated fuel that has flowed through the vaper passage is adsorbed. The evaporated fuel processing device of Patent Document 1 further includes a pressurizing pump that is connected in a canister-side area which is closer to the canister than the closing valve and is configured to pressurize a system including the canister and the fuel tank, and at least one pressure sensor configured to detect the pressure in the system. In the evaporated fuel processing device of Patent Document 1, the pump starts the pressurization with the closing valve closed, the closing valve is then opened after a predetermined time period to bring the system to a pressurized state, and whether leakage from the system is present is determined (first leak test) based on a pressure change in the system from the pressurized state. Further, in the evaporated fuel processing device of Patent Docment 1, after the system has entirely been brought to the pressurized state by having opened the closing valve, the closing valve is closed and whether the leakage is present is determined (second leak test) for each of the canister-side area and a fuel tank-side area.

### SUMMARY

In the evaporated fuel processing device of Patent Document 1, the first leak test is executed with the closing valve opened. However, the evaporated fuel may leak from the closing valve even though the closing valve closed, for example, if the closing valve has a defect. The first leak test cannot determine whether leakage from the closing valve is present or not when the closing valve is closed. Although the second leak test, in addition to the first leak test, is executed with the closing valve closed in the evaporated fuel processing device of Patent Document 1, leakage from the closing valve may not be determined accurately. For example, if a difference between a pressure in the vapor passage upstream of the closing valve and a pressure in the vapor passage downstream of the closing valve is large when the closing valve is in a closed state due to a defect in the closing valve, gas (e.g., evaporated fuel) may not leak from the closing valve, while if the difference is small, the gas may leak from the closing valve. In such a case, the evaporated fuel processing device of Patent Document 1 cannot accurately determine the leakage from the closing valve. In view of this, the disclosure herein provides a technique that makes it possible to accurately determine the presence of leakage from a closing valve when the closing valve is in a closed state.

An evaporated fuel processing device disclosed herein may comprise a fuel tank; a vapor passage through which evaporated fuel generated from fuel in the fuel tank flows; a closing valve configured to open and close the vapor passage; a first pressure sensor configured to detect a pressure in the vapor passage upstream of the closing valve directly or indirectly; and/or a second pressure sensor configured to detect a pressure in the vapor passage downstream of the closing valve directly or indirectly; and a controller. When the closing valve is in a closed state, the controller may determine presence of leakage from the closing valve based on: the pressure detected by the first pressure sensor and/or the pressure detected by the second pressure sensor detected when a difference between the pressure in the vapor passage upstream of the closing valve and the pressure in the vapor passage downstream of the closing valve is a first difference; and the pressure detected by the first pressure sensor and/or the pressure detected by the second pressure sensor detected when the difference is a second difference different from the first difference.

### BRIEF DESCRIPTION OF DRAWINGS

FIG. 1 schematically shows an evaporated fuel processing device according to an embodiment.

FIG. 2 shows a cross-sectional view of a closing valve according to the embodiment.

FIG. 3 shows a cross-sectional view of a canister according to the embodiment.

FIG. 4 is a flowchart of a determination process according to the embodiment.

FIG. 5 is a flowchart of a first determination process according to the embodiment.

FIG. 6 is a flowchart of a pressure adjusting process according to the embodiment.

FIG. 7 is a flowchart of a second determination process according to the embodiment.

FIG. 8 is a flowchart of a third determination process according to the embodiment.

FIG. 9 is a flowchart (1) of a valve-opening-start position specifying process according to the embodiment.

FIG. 10 is a flowchart (2) of the valve-opening-start position specifying process according to the embodiment.

FIG. 11 is a flowchart of a reinitialization process according to the embodiment.

FIG. 12 is a flowchart of an electrical continuity controlling process according to the embodiment.

### DETAILED DESCRIPTION

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved evaporated fuel processing devices, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

An evaporated fuel processing device disclosed herein may comprise a fuel tank; a vapor passage through which evaporated fuel generated from fuel in the fuel tank flows; a closing valve configured to open and close the vapor passage; a first pressure sensor configured to detect a pressure in the vapor passage upstream of the closing valve directly or indirectly; and/or a second pressure sensor configured to detect a pressure in the vapor passage downstream of the closing valve directly or indirectly; and a controller. When the closing valve is in a closed state, the controller may determine presence of leakage from the closing valve based on: the pressure detected by the first pressure sensor and/or the pressure detected by the second pressure sensor detected when a difference between the pressure in the vapor passage upstream of the closing valve and the pressure in the vapor passage downstream of the closing valve is a first difference; and the pressure detected by the first pressure sensor and/or the pressure detected by the second pressure sensor detected when the difference is a second difference different from the first difference.

While the closing valve is in the closed state, the evaporated fuel does not leak from the closing valve when the difference between the pressure in the vapor passage upstream of the closing valve and the pressure in the vapor passage downstream of the closing valve is the first difference, but the evaporated fuel may leak from the closing valve when the difference is the second difference. In the above configuration, the presence of the leakage from the closing valve is determined based on the detected pressure(s) by the pressure sensor(s) detected when the pressure difference is the first difference and the detected pressure(s) by the pressure sensor(s) detected when the pressure difference is the second difference. According to this configuration, it is possible, even when the closing valve is in the closed state, to accurately determine the presence of leakage from the closing valve by determining it using the different pressure differences.

When the closing valve is in the closed state, the closing valve may be settable to either one of a first position and a second position that is closer to an opened state of the closing valve than the first position. The controller may determine the presence of the leakage when the closing valve is at the second position.

According to this configuration, the presence of leakage from the closing valve can be determined when the closing valve is at a position that is close to a valve-opening-start position where the closing valve transitions from the closed state to an opened state. In the evaporated fuel processing device, the closing valve may need to be switched quickly from the closed state to the opened state quickly, for example, for an evaporated fuel purging process. For this reason, the closing valve may need to be set to a position close to the valve-opening-start position. According to the above configuration, the presence of leakage from the closing valve can be determined when the closing valve is at a position close to the valve-opening-start position, and thus this is especially efficient for quick switching of the closing valve from the closed state to the opened state.

The evaporated fuel processing device may further comprise a stepping motor configured to actuate the closing valve. The closing valve may be set to the second position based on a number of steps by which the stepping motor has rotated.

In the configuration in which the stepping motor actuates the closing valve, it may take long for the closing valve to reach the valve-opening-start position since the closing valve moves step by step in accordance with the number of steps by which the stepping motor has rotated. According to the above configuration, the closing valve can be set to a position close to the valve-opening-start position in determining the presence of leakage from the closing valve. Thus, even in the configuration in which the closing valve is actuated by the stepping motor, it is possible to make the closing valve reach the valve-opening-start position quickly after the determination on the leakage from the closing valve.

The controller may specify a valve-opening-start position of the closing valve based on the pressure detected by the first pressure sensor and/or the pressure detected by the second pressure sensor. The valve-opening-start position is a position where the closing valve transitions from the closed state to an opened state.

According to this configuration, it is possible to execute the determination on the leakage from the closing valve and the specifying of the valve-opening-start position of the closing valve successively. It is also possible to specify the valve-opening-start position of the closing valve by using the difference(s) between the pressures upstream and downstream of the closing valve which is(are) used in the leakage determination.

(Configuration of Evaporated Fuel Processing Device 1)

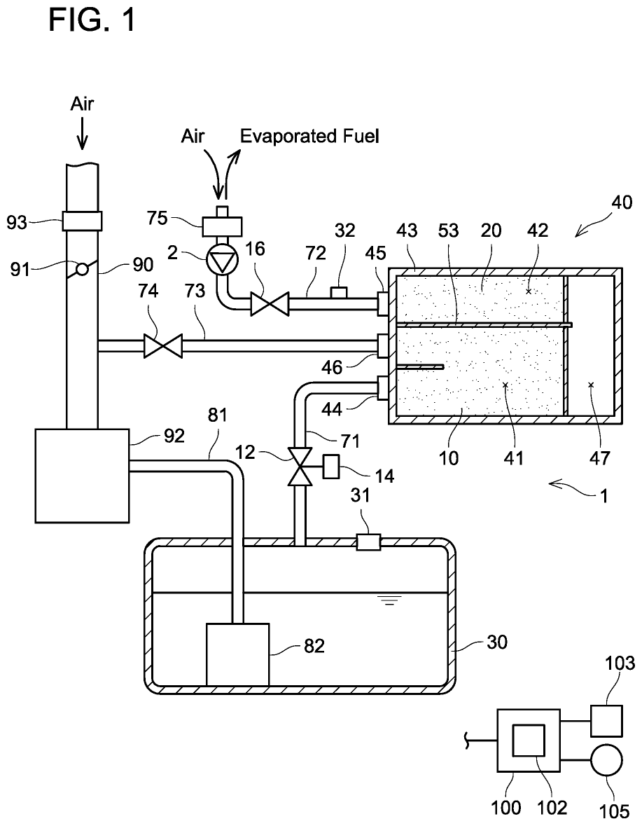

An evaporated fuel processing device 1 according to an embodiment will be described with reference to the drawings. FIG. 1 schematically shows the evaporated fuel processing device 1 according to the embodiment. As shown in FIG. 1, the evaporated fuel processing device 1 includes a fuel tank 30, a canister 40, and a controller 100. Further, the evaporated fuel processing device 1 also includes a vapor passage 71, an open air passage 72, and a purge passage 73. This evaporated fuel processing device 1 is mounted in a vehicle such as a gasoline-fueled vehicle or a hybrid vehicle.

The fuel tank 30 is configured to store fuel such as gasoline. The fuel is poured into the fuel tank 30 from an inlet (not shown). A fuel pump 82 is disposed in the fuel tank 30. A fuel passage 81 is connected to the fuel pump 82. The fuel pump 82 is configured to discharge the fuel in the fuel tank 30 to the fuel passage 81. The fuel discharged into the fuel passage 81 is supplied to an engine 92 of the vehicle through the fuel passage 81.

The fuel in the fuel tank 30 may evaporate within the fuel tank 30. For example, the fuel may evaporate while the vehicle in which the evaporated fuel processing device 1 is mounted is traveling. The fuel may also evaporate during when the vehicle in which the evaporated fuel processing device 1 is mounted is parked. Evaporated fuel is generated in the fuel tank 30 by the fuel evaporating in the fuel tank 30.

A first pressure sensor 31 is disposed at the fuel tank 30. The first pressure sensor 31 is configured to detect the pressure in the fuel tank 30. The first pressure sensor 31 can indirectly detect the pressure in the vapor passage 71 upstream of (on the fuel tank 30 side relative to) a closing valve 12 (which will be described later) by detecting the pressure in the fuel tank 30. When the first pressure sensor 31 detects the pressure in the fuel tank 30, information on the detected pressure is sent to the controller 100. The controller 100 obtains the information on the detected pressure. Hereinbelow, the detected pressure by the first pressure sensor 31 may be termed the first detected pressure.

An upstream end of the vapor passage 71 is connected to the fuel tank 30. Gas that contains the evaporated fuel generated in the fuel tank 30 flows into the vapor passage 71. A downstream end of the vapor passage 71 is connected to the canister 40. The gas having flowed through the vapor passage 71 flows into the canister 40. The vapor passage 71 delivers the gas containing the evaporated fuel generated in the fuel tank 30 from the fuel tank 30 to the canister 40.

The closing valve 12 is disposed on the vapor passage 71. The closing valve 12 is configured to open and close the vapor passage 71. The closing valve 12 may, for example, be a globe valve, a ball valve, a gate valve, a butterfly valve, or a diaphragm valve. When the closing valve 12 is in an opened state, the gas in the vapor passage 71 flows through the closing valve 12. For example, when the closing valve 12 transitions to the opened state, the gas containing the evaporated fuel generated from the fuel in the fuel tank 30 flows through the closing valve 12. When the closing valve 12 transitions to a closed state, the gas in the vapor passage 71 does not flow through the closing valve 12. The evaporated fuel processing device 1 is of a so-called fuel vapor-containment type in which the fuel tank 30 is sealed by the closing valve 12.

The closing valve 12 is actuated by a stepping motor 14. The stepping motor 14 is attached to the closing valve 12 and is configured to actuate the closing valve 12. In a variant, the stepping motor 14 may be incorporated in the closing valve 12. The stepping motor 14 causes the closing valve 12 to move to an open side or to a closing side. For example, as the number of steps by which the stepping motor 14 has rotated (which will be termed “the number of steps of the stepping motor 14”) increases, the closing valve 12 moves toward the open side. On the other hand, as the number of steps of the stepping motor 14 decreases, the closing valve 12 moves to the closing side. The stepping motor 14 is configured such that its rotation angle changes as the number of steps changes based on pulse signals. The rotation angle per one step of the stepping motor 14 may, for example, be 0.72 degrees. The opening degree of the closing valve 12 corresponds to the number of steps of the stepping motor 14.

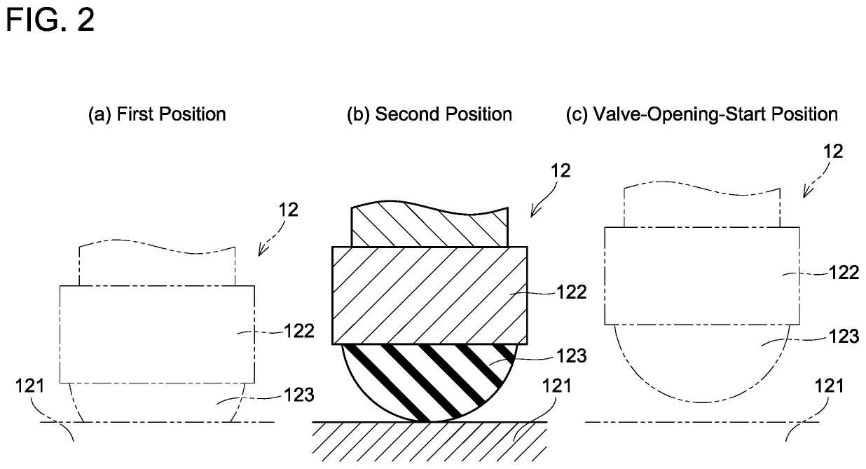

As shown in FIG. 2, the closing valve 12 includes a valve seat 121, a valve body 122, and a seal member 123 that is constituted of resin (e.g., rubber) and is disposed between the valve seat 121 and the valve body 122. The valve seat 121 and the valve body 122 are arranged to face each other. The valve body 122 is configured to approach or move away from the valve seat 121. When the closing valve 12 moves toward the closing side, the valve body 122 approaches the valve seat 121. When the closing valve 12 moves toward the open side, the valve body 122 moves away from the valve seat 121.

The seal member 123 is fixed to the valve body 122 and is configured to contact or separate from the valve seat 121. When the valve body 122 approaches the valve seat 121, the seal member 123 contacts the valve seat 121. By the seal member 123 contacting the valve seat 121, the closing valve 12 transitions to the closed state. The seal member 123 seals between the valve seat 121 and the valve body 122. If the seal member 123 has a defect, the gas containing the evaporated fuel may leak from the closing valve 12 even though the closing valve 12 is in the closed state. Examples of the defect of the seal member 123 include a duck bill-shaped scarring and the like. When the valve body 122 moves away from the valve seat 121, the seal member 123 separates from the valve seat 121. By the seal member 123 separating from the valve seat 121, the closing valve 12 transitions to the opened state.

As shown in FIGS. 2(a) and (b), the closing valve 12 is settable to either one of a first position and a second position when it is in the closed state. At the first position of the closing valve 12, the valve body 122 is sufficiently close to the valve seat 121 as a result of the closing valve 12 having moved toward the closing side sufficiently. At the first position, the seal member 123 is compressed sufficiently by the valve body 122 and the valve seat 121. The closing valve 12 is set to the first position, for example, by initialization of the stepping motor 14 being executed.

The second position of the closing valve 12 is closer to the opened state than the first position. For example, the second position is a position right before the seal member 123 separates from the valve seat 121 as the closing valve 12 moves toward the open side from the first position and the valve body 122 moves away from the valve seat 121. The second position can be considered as a standby position that is right before a valve-opening-start position at which the closing valve 12 transitions from the closed state to the opened state. The second position is between the first position and the valve-opening-start position. The seal member 123 is less compressed at the second position of the closing valve 12 than at the first position.

As shown in FIG. 2(c), the valve-opening-start position of the closing valve 12 is where the closing valve 12 transitions from the closed state to the opened state. At a certain point while the closing valve 12 is moving toward the open side in the closed state, the closing valve 12 transitions from the closed state to the opened state. The valve-opening-start position is where the seal member 123 of the closing valve 12 separates from the valve seat 121.

Leakage from the closing valve 12 shown in FIGS. 1 and 2 when it is in the closed state may differ depending on whether the difference between the pressure in the vapor passage 71 upstream of the closing valve 12 and the pressure in the vapor passage 71 downstream of the closing valve 12 is large or small due to a defect in the seal member 123. That is, the gas (e.g., evaporated fuel) does not leak from the closing valve 12 when the difference between the pressure in the vapor passage 71 upstream of the closing valve 12 and the pressure in the vapor passage 71 downstream of the closing valve 12 is large, while the gas may leak from the closing valve 12 when the pressure difference is small. Such phenomena may occur when the closing valve 12 is set, for example, to the second position in the closed state.

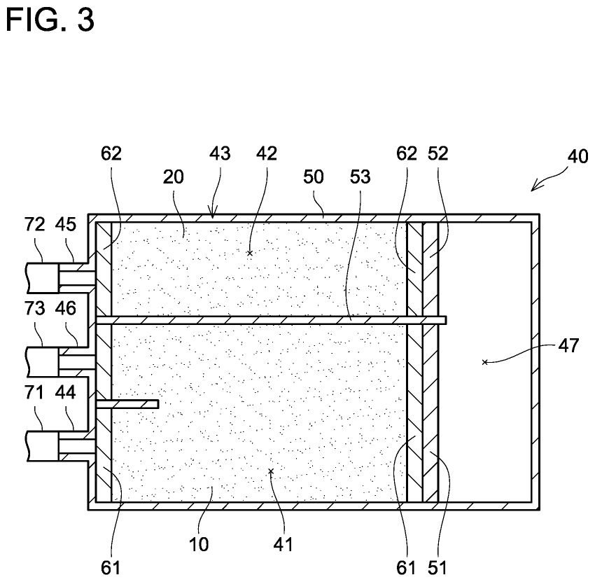

Next, the canister 40 will be described. FIG. 3 is a cross-sectional view of the canister 40. As shown in FIG. 3, the canister 40 includes a casing 43 and a plurality of ports (a tank port 44, an open air port 45, and a purge port 46). The casing 43 and the plurality of ports (the tank port 44, the open air port 45, and the purge port 46) may, for example, be constituted of resin. The casing 43 is integral with the plurality of ports (the tank port 44, the open air port 45, and the purge port 46).

The casing 43 includes a casing body 50 and a partitioning wall 53. The casing body 50 is integral with the partitioning wall 53. The partitioning wall 53 is disposed in the casing body 50 and partitions a space inside the casing body 50. A first chamber 41 and a second chamber 42 are defined within the casing body 50 by the space in the casing body 50 being partitioned by the partitioning wall 53. A first adsorbent 10 is housed in the first chamber 41. A second adsorbent 20 is housed in the second chamber 42.

The first chamber 41 is located upstream of (on the fuel tank 30 side relative to) the second chamber 42 (see FIG. 1). A first porous plate 51 and a pair of first filters 61 are disposed in the first chamber 41. The first porous plate 51 is arranged at a downstream end of the first chamber 41. A plurality of pores (not shown) is formed in the first porous plate 51. Gas flowing in the first chamber 41 flows through the plurality of pores formed in the first porous plate 51. The first filters 61 are arranged at upstream and downstream ends of the first chamber 41, respectively. The first adsorbent 10 is interposed between the pair of first filters 61. The first filters 61 are configured to remove foreign matters contained in the gas flowing in the first chamber 41.

The first adsorbent 10 in the first chamber 41 is constituted of active carbon, for example. The active carbon constituting the first adsorbent 10 has an ability to adsorb the evaporated fuel. While the gas containing the evaporated fuel is flowing through the first adsorbent 10, a part of the evaporated fuel in the gas is adsorbed by the active carbon. Further, while air is flowing through the first adsorbent 10, the evaporated fuel adsorbed on the active carbon is desorbed into the air from the active carbon (i.e., the evaporated fuel is purged). The active carbon may, for example, be in the form of pellets or monolith. Granulated carbon or crushed carbon may be used as the active carbon, for example. Coal-based or wood-based active carbon may be used as the active carbon, for example. In a variant, the first adsorbent 10 may be constituted of a porous metal complex.

The second chamber 42 is located downstream of (on the opposite side from the fuel tank 30 (open air side) relative to) the first chamber 41 (see FIG. 1). A second porous plate 52 and a pair of second filters 62 are disposed in the second chamber 42. The second porous plate 52 is arranged at an upstream end of the second chamber 42. A plurality of pores (not shown) is formed in the second porous plate 52. Gas flowing in the second chamber 42 flows through the plurality of pores formed in the second porous plate 52. The second filters 62 are arranged at upstream and downstream ends of the second chamber 42, respectively. The second adsorbent 20 is interposed between the pair of second filters 62. The second filters 62 are configured to remove foreign matters contained in the gas flowing in the second chamber 42.

The second adsorbent 20 in the second chamber 42 is constituted of a porous metal complex, for example. The porous metal complex constituting the second adsorbent 20 has an ability to adsorb the evaporated fuel. While the gas containing the evaporated fuel is flowing through the second adsorbent 20, a part of the evaporated fuel in the gas is adsorbed by the porous metal complex. Further, while air is flowing through the second adsorbent 20, the evaporated fuel adsorbed on the porous metal complex is desorbed into the air from the porous metal complex (i.e., the evaporated fuel is purged). For example, the porous metal complex may be in the form of pellets or monolith, or may be in the form of a thin film in which the porous metal complex is applied on a substrate with air permeability. In a variant, the second adsorbent 20 may be constituted of active carbon.

An intermediate chamber 47 is defined between the first chamber 41 and the second chamber 42. The intermediate chamber 47 is defined in the casing body 50 by the space in the casing body 50 being partitioned by the first porous plate 51 and the second porous plate 52.

The tank port 44 of the canister 40 is located adjacent to the first chamber 41 of the casing 43. The tank port 44 is in communication with the first chamber 41. The downstream end of the vapor passage 71 is connected to the tank port 44. The vapor passage 71 is in communication with the first chamber 41 through the tank port 44. The gas having flowed through the vapor passage 71 flows into the first chamber 41 through the tank port 44.

The open air port 45 of the canister 40 is located adjacent to the second chamber 42 of the casing 43. The open air port 45 is in communication with the second chamber 42. An upstream end of the open air passage 72 is connected to the open air port 45. The second chamber 42 is in communication with the open air passage 72 through the open air port 45. The gas having flowed through the second chamber 42 flows into the open air passage 72 through the open air port 45.

A downstream end of the open air passage 72 is open to open air (see FIG. 1). The gas having flowed through the open air passage 72 is discharged to the open air. When the evaporated fuel is desorbed (which will be described later), air from the open air flows into the open air passage 72 from the downstream end of the open air passage 72. The air having flowed into the open air passage 72 flows through the open air passage 72 into the second chamber 42 of the casing 43 through the open air port 45. An air filter 75 is disposed on the open air passage 72. The air filter 75 is configured to remove foreign matters contained in the air flowing into the open air passage 72.

An open air valve 16, a pressurizing pump 2, and a second pressure sensor 32 are disposed on the open air passage 72. The open air valve 16 is configured to open and close the open air passage 72. The open air valve 16 may, for example, be a globe valve, a ball valve, a gate valve, a butterfly valve, or a diaphragm valve. When the open air valve 16 is in an opened state, gas in the open air passage 72 flows through the open air valve 16. For example, when the open air valve 16 transitions to the opened state, air from the open air flows through the open air valve 16. When the open air valve 16 transitions to a closed state, gas in the open air passage 72 cannot flow through the open air valve 16.

The pressurizing pump 2 is disposed downstream of (on the open air side relative to) the open air valve 16. The pressurizing pump 2 is configured to pressurize the gas in the open air passage 72 toward the canister 40. By pressurizing the gas in the open air passage 72, the pressurizing pump 2 indirectly pressurizes the gas in the canister 40, the gas in the purge passage 73, and the gas in the vapor passage 71. When the closing valve 12, which is configured to open and close the vapor passage 71, is in the closed state, the pressurizing pump 2 pressurizes the gas in the vapor passage 71 downstream of the closing valve 12 toward the closing valve 12 (toward the upstream side). The type of the pressurizing pump 2 is not particularly limited.

The second pressure sensor 32 is configured to detect the pressure in the open air passage 72. When the second pressure sensor 32 detects the pressure in the open air passage 72, information on the detected pressure is sent to the controller 100. The controller 100 obtains the information on the detected pressure. The open air passage 72 is in communication with the vapor passage 71 through the canister 40. Thus, the pressure in the open air passage 72 is substantially equal to the pressure in the vapor passage 71. When the closing valve 12 is in the closed state, the pressure in the open air passage 72 is substantially equal to the pressure in the vapor passage 71 downstream of the closing valve 12. By detecting the pressure in the open air passage 72, the second pressure sensor 32 indirectly detects the pressure in the vapor passage 71 (the pressure in the vapor passage 71 downstream of the closing valve 12 when the closing valve 12 is in the closed state). Hereinbelow, the detected pressure by the second pressure sensor 32 may be termed the second detected pressure.

The purge port 46 of the canister 40 is located adjacent to the first chamber 41 of the casing 43. The purge port 46 is in communication with the first chamber 41. An upstream end of the purge passage 73 is connected to the purge port 46. The first chamber 41 is in communication with the purge passage 73 through the purge port 46. The gas having flowed through the first chamber 41 flows into the purge passage 73 through the purge port 46.

A downstream end of the purge passage 73 is connected to an intake passage 90. The gas having flowed through the purge passage 73 flows into the intake passage 90. A purge valve 74 is disposed on the purge passage 73. The purge valve 74 is configured to open and close the purge passage 73. When the purge valve 74 is in an opened state, gas flows through the purge passage 73. A pump (not shown) may be disposed on the purge passage 73.

An upstream end of the intake passage 90 is open to the open air. Air from the open air flows into the intake passage 90. A downstream end of the intake passage 90 is connected to the engine 92 of the vehicle. The air having flowed through the intake passage 90 flows into the engine 92.

An air cleaner 93 and a throttle valve 91 are disposed on the intake passage 90. The air cleaner 93 is configured to remove foreign matters, such as dust, in the air flowing into the intake passage 90. The throttle valve 91 is configured to change a cross-sectional area of the intake passage 90. The flow rate of air flowing in the intake passage 90 is thereby adjusted, and thus the flow rate of air flowing into the engine 92 is adjusted.

The controller 100 of the evaporated fuel processing device 1 includes, for example, a CPU (not shown) and a memory 102 (such as ROM, RAM, etc.) and is configured to execute predetermined control and processes based on a predetermined program. The controller 100 may also be called an ECU (engine control unit). The control and processes executed by the controller 100 will be described later. An ignition switch 105 (hereinbelow termed “IG switch”) for turning the engine 92 of the vehicle on and off is connected to the controller 100. Further, a notifier 103 configured to notify of abnormality on the evaporated fuel processing device 1 is connected to the controller 100. The notifier 103 is, for example, a lamp, a display, or the like.

(Operation of Evaporated Fuel Processing Device 1)

(Adsorbing Process)

Next, operation of the evaporated fuel processing device 1 will be described. Firstly, an adsorbing process in which the evaporated fuel is adsorbed in the canister 40 will be described. Here, how the evaporated fuel processing device 1 operates when the closing valve 12 on the vapor passage 71 and the open air valve 16 on the open air passage 72 are both in the opened state will be described. In the evaporated fuel processing device 1, the gas containing the evaporated fuel generated from the fuel in the fuel tank 30 flows from the fuel tank 30 into the vapor passage 71. The gas containing the evaporated fuel having flowed into the vapor passage 71 flows through the closing valve 12 in the opened state, and then flows to a downstream portion of the vapor passage 71. After this, the gas containing the evaporated fuel having flowed through the vapor passage 71 flows into the first chamber 41 in the canister body 50 through the tank port 44 of the canister 40. When the closing valve 12 is in the closed state, the flow of the gas is cut off in the vapor passage 71.

The gas containing the evaporated fuel having flowed from the vapor passage 71 into the first chamber 41 flows through the first adsorbent 10 housed in the first chamber 41 into the intermediate chamber 47. While the gas containing the evaporated fuel is flowing through the first adsorbent 10, the first adsorbent 10 adsorbs a part of the evaporated fuel in the gas. The evaporated fuel is adsorbed on the active carbon constituting the first adsorbent 10. The evaporated fuel that was not adsorbed by the active carbon flows from the first chamber 41 into the intermediate chamber 47.

The gas containing the evaporated fuel having flowed into the intermediate chamber 47 through the first adsorbent 10 flows into the second chamber 42. The gas containing the evaporated fuel having flowed into the second chamber 42 flows through the second adsorbent 20 housed in the second chamber 42 into the open air passage 72 through the open air port 45. While the gas containing the evaporated fuel is flowing through the second adsorbent 20, the second adsorbent 20 adsorbs a part of the evaporated fuel in the gas. The evaporated fuel is adsorbed on the porous metal complex constituting the second adsorbent 20. The evaporated fuel that was not adsorbed by the porous metal complex flows from the second chamber 42 into the open air passage 72.

The gas containing the evaporated fuel having flowed into the open air passage 72 through the second adsorbent 20 is discharged into the open air. The evaporated fuel that was not adsorbed by the first adsorbent 10 (e.g., active carbon) nor the second adsorbent 20 (e.g., porous metal complex) is discharged to the open air.

(Desorbing Process)

Next, a desorbing process (purge process) in which the evaporated fuel is desorbed from the canister 40 will be described. In the evaporated fuel processing device 1, gas can flow through the purge passage 73 when the purge valve 74 on the purge passage 73 is in the opened state. Further, when the engine 92 of the vehicle in which the evaporated fuel processing device 1 is mounted starts to operate, air in the intake passage 90 is suctioned into the engine 92 and a negative pressure is applied in the intake passage 90. Thereby, the gas flows from the purge passage 73 into the intake passage 90. Along with this, air from the open air flows into the open air passage 72. The air having flowed into the open air passage 72 flows into the second chamber 42 in the casing body 50 through the open air port 45 of the canister 40. The air having flowed into the second chamber 42 flows through the second adsorbent 20 housed in the second chamber 42 into the intermediate chamber 47. While the air is flowing through the second adsorbent 20, the evaporated fuel adsorbed on the second adsorbent 20 is desorbed from the second adsorbent 20 into the air. That is, the evaporated fuel is purged. The air containing the purged evaporated fuel flows from the second chamber 42 into the intermediate chamber 47.

The air containing the evaporated fuel having flowed into the intermediate chamber 47 flows into the first chamber 41. The air having flowed into the first chamber 41 flows through the first adsorbent 10 housed in the first chamber 41 into the purge passage 73 through the purge port 46. While the air is flowing through the first adsorbent 10, the evaporated fuel adsorbed on the first adsorbent 10 is desorbed from the first adsorbent 10 to the air. That is, the evaporated fuel is purged. The air containing the purged evaporated fuel flows from the first chamber 41 into the purge passage 73.

The air containing the evaporated fuel having flowed into the purge passage 73 flows through the purge passage 73 into the intake passage 90. The air containing the evaporated fuel having flowed into the intake passage 90 is suctioned into the engine 92.

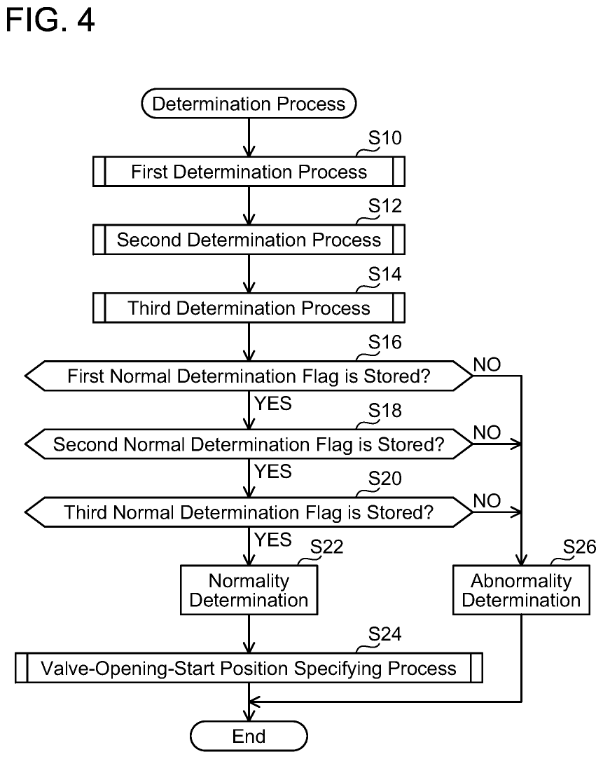

(Determination Process; FIG. 4)

Next, a determination process executed at the evaporated fuel processing device 1 will be described. In the determination process, whether leakage from the closing valve 12 is present can be determined when the closing valve 12 on the vapor passage 71 is in the closed state. Further, in the determination process, the valve-opening-start position where the closing valve 12 transitions from the closed state to the opened state can be specified. FIG. 4 shows a flowchart of the determination process. The determination process is started, for example, when the IG switch 105 of the vehicle in which the evaporated fuel processing device 1 is mounted is turned on. The IG switch 105 is turned on, for example, when a start button of the engine 92 is pressed by a driver of the vehicle.

As shown in FIG. 4, in S10 of the determination process, the controller 100 executes a first determination process. In the first determination process, a first normal determination flag is set if it is determined that the closing valve 12 is normal (if it is determined that there is no leakage from the closing valve 12). The first normal determination flag is stored in the memory 102 of the controller 100. The first determination process will be described later in detail.

In S12, the controller 100 executes a second determination process. In S14, the controller 100 executes a third determination process. In the second determination process, similar to the first determination process, a second normal determination flag is set if it is determined that the closing valve 12 is normal (if it is determined that there is no leakage from the closing valve 12). Similarly, in the third determination process, a third normal determination flag is set if it is determined that the closing valve 12 is normal (if it is determined that there is no leakage from the closing valve 12). The second and third normal determination flags are stored in the memory 102 of the controller 100. The second and third determination processes will be described later in detail.

In S16, the controller 100 determines whether the first normal determination flag is stored in the memory 102. If the first normal determination flag had been set in the first determination process (S10), it should be stored in the memory 102. If the first normal determination flag is stored, the controller 100 determines YES in S16 and proceeds to S18. If not, the controller 100 determines NO and proceeds to S26.

In S18, the controller 100 determines whether the second normal determination flag is stored in the memory 102. In S20, the controller 100 determines whether the third normal determination flag is stored in the memory 102. If the second normal determination flag had been set in the second determination process (S12), it should be stored in the memory 102, and if the third normal determination flag had been set in the third determination process (S14), it should be stored in the memory 102. If determining YES in S18, the controller 100 proceeds to S20. If determining YES in S20, the controller 100 proceeds to S22. If determining NO in S18 or NO in S20, the controller 100 proceeds to S26.

In S22 following YES in S20, the controller 100 determines that the closing valve 12 is normal (i.e., determines that there is no leakage from the closing valve 12). In S24, the controller 100 executes a valve-opening-start position specifying process. The valve-opening-start position specifying process will be described later in detail. In S26 following NO in S16, NO in S18, or NO in S20, the controller 100 determines that the closing valve 12 is abnormal (i.e., determines that leakage from the closing valve 12 is present).

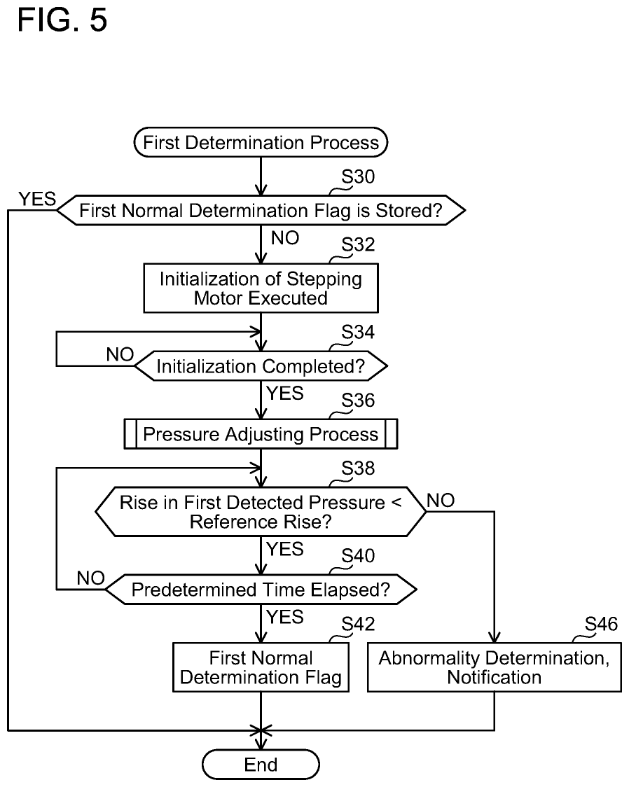

(First Determination Process; FIG. 5)

Next, the first determination process (see S10 in FIG. 4) will be described in detail. In the first determination process, whether leakage from the closing valve 12 is present or not when the closing valve 12 is at the first position can be determined. FIG. 5 shows a flowchart of the first determination process. As shown in FIG. 5, in S30 of the first determination process, the controller 100 determines whether the first normal determination flag is stored in the memory 102. If the first normal determination flag set in the previous first determination process has not been deleted, the first normal determination flag is still in the memory 102. If determining YES in S30, the controller 100 ends the first determination process, while if determining NO, the controller 100 proceeds to S32.

In S32 following NO in S30, the controller 100 executes initialization of the stepping motor 14 which actuates the closing valve 12. The initialization of the stepping motor 14 is a process of setting an initial value of the stepping motor 14 by decreasing the number of steps of the stepping motor 14 (i.e., by rotating the stepping motor 14 in a negative direction). As a result of the initialization of the stepping motor 14, the initial value of the stepping motor 14 is set. Further, as a result of the initialization of the stepping motor 14, the closing valve 12 is moved to the closing side and is set at the first position (see FIG. 2).

In S34, the controller 100 determines whether the initialization of the stepping motor 14 is completed. Whether the initialization is completed or not is determined, for example, based on whether the number of steps of the stepping motor 14 has been sufficiently decreased to bring the closing valve 12 into the closed state. If the initialization is completed, the controller 100 determines YES in S34 and proceeds to S36. If not, the controller 100 determines NO and waits.

In S36, the controller 100 executes a pressure adjusting process. In the pressure adjusting process, the pressure in the vapor passage 71 downstream of the closing valve 12 is adjusted such that it becomes higher than the pressure in the vapor passage 71 upstream of the closing valve 12. The pressure adjusting process will be described later in detail.

In S38, the controller 100 determines whether a rise in the first detected pressure (detected pressure by the first pressure sensor 31) after the completion of the pressure adjusting process of S36 is less than a predetermined reference rise. The predetermined reference rise may be set at any value appropriately. If the rise in the first detected pressure is less than the reference rise, the controller 100 determines YES in S38 and proceeds to S40. If not (if the rise in the first detected pressure is equal to or greater than the reference rise), the controller 100 determines NO and proceeds to S46.

The rise in the first detected pressure being equal to or greater than the reference rise means that gas in the vapor passage 71 downstream of the closing valve 12 flows through the closing valve 12 even though the closing valve 12 is set at the first position and the pressure in the fuel tank 30 is thereby increased. In this case, it can be determined that leakage from the closing valve 12 is present. Thus, in S46 following NO in S38, the controller 100 determines that the closing valve 12 is abnormal and notifies of this abnormality from the notifier 103. For example, the controller 100 turns on the lamp of the notifier 103.

In S40 following YES in S38, the controller 100 determines whether a predetermined time has elapsed since the end of the pressure adjusting process in S36. The predetermined time may be set at any value appropriately. If the predetermined time has elapsed, the controller 100 determines YES and proceeds to S42. If not, the controller 100 determines NO and returns to S38. The predetermined time having elapsed with the rise in the first detected pressure remaining less than the reference rise (YES in S38, YES in S40) means that there is no leakage from the closing valve 12 when the closing valve 12 is at the first position. Thus, in S42 following YES in S40, the controller 100 sets the first normal determination flag. The first normal determination flag is information indicating that there is no leakage from the closing valve 12 in the first determination process. The controller 100 ends the first determination process after S42 or S46.

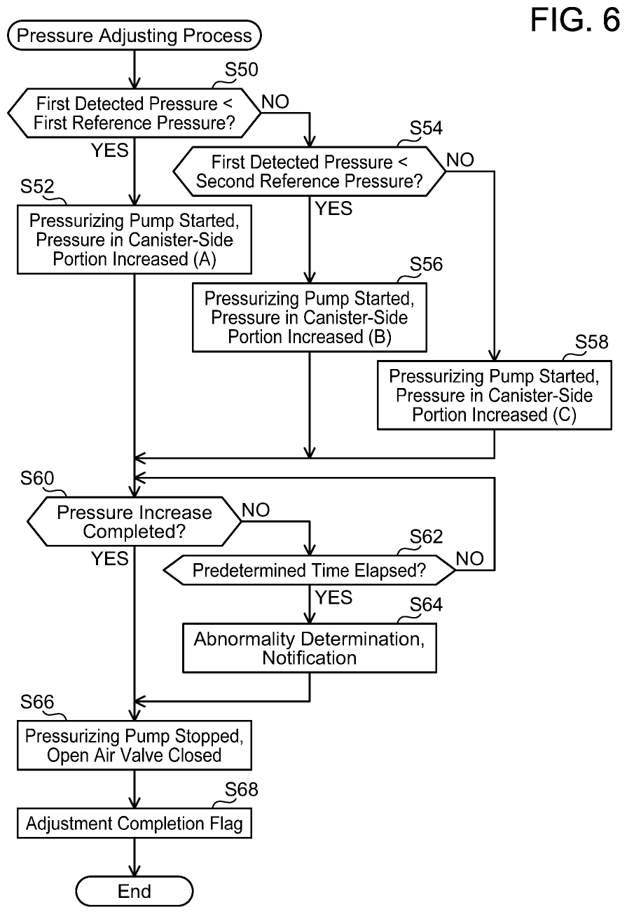

(Pressure Adjusting Process; FIG. 6)

Next, the pressure adjusting process (see S36 in FIG. 5) will be described in detail. FIG. 6 shows a flowchart of the pressure adjusting process. As shown in FIG. 6, in S50 of the pressure adjusting process, the controller 100 determines whether the first detected pressure (detected pressure by the first pressure sensor 31) is less than a predetermined first reference pressure. The first reference pressure may be set at any value appropriately. The first reference pressure is, for example, a pressure that is less than atmospheric pressure. If the first detected pressure is less than the first reference pressure, the controller 100 determines YES in S50 and proceeds to S52. If not (if the first detected pressure is equal to or greater than the first reference pressure), the controller 100 determines NO and proceeds to S54.

In S54 following NO in S50, the controller 100 determines whether the first detected pressure is less than a predetermined second reference pressure. The second reference pressure is a pressure that is greater than the first reference pressure and the atmospheric pressure. The second reference pressure may be set at any value appropriately. If the first detected pressure is less than the second reference pressure, the controller 100 determines YES in S54 and proceeds to S56. If not (if the first detected pressure is equal to or greater than the second reference pressure), the controller 100 determines NO and proceeds to S58.

In S52 following YES in S50, the controller 100 starts the pressurizing pump 2 on the open air passage 72 to raise the pressure in a portion that is located on the canister 40 side relative to the closing valve 12. The pressure in the vapor passage 71 downstream of the closing valve 12 is thereby raised. The controller 100 executes the process of S52 such that the pressure in the vapor passage 71 downstream of the closing valve 12 becomes greater than the pressure in the vapor passage 71 upstream of the closing valve 12. The pressure rise in S52 is labeled as “A”, for example. In a variant, the pressure in the portion on the canister 40 side may not be raised in S52.

In S56 following YES in S54, as in S52, the controller 100 starts the pressurizing pump 2 to raise the pressure in the portion on the canister 40 side relative to closing valve 12. The pressure in the vapor passage 71 downstream of the closing valve 12 is thereby raised. The controller 100 executes the process of S56 such that the pressure in the vapor passage 71 downstream of the closing valve 12 becomes greater than the pressure in the vapor passage 71 upstream of the closing valve 12. The pressure rise in S56 is labeled as “B”, for example. The pressure rise “B” in S56 is greater than the pressure rise “A” in S52, which means B>A.

In S58 following NO in S54, as in S52, the controller 100 starts the pressurizing pump 2 to raise the pressure in the portion on the canister 40 side relative to closing valve 12. The pressure in the vapor passage 71 downstream of the closing valve 12 is thereby raised. The controller 100 executes the process of S58 such that the pressure in the vapor passage 71 downstream of the closing valve 12 becomes greater than the pressure in the vapor passage 71 upstream of the closing valve 12. The pressure rise in S58 is labeled as “C”, for example. The pressure rise “C” in S58 is greater than the pressure rise “B” in S56, which means C>B.

In S60 following S52, S56, or S58, the controller 100 determines whether pressurization in S52, S56, or S58 is completed. That is, the controller 100 determines whether the pressure rise “A”, “B”, or “C” in S52, S56, or S58 has been achieved. The controller 100 determines whether the pressurization is completed, for example, based on the second detected pressure (detected pressure by the second pressure sensor 32). If the pressurization is completed, the controller 100 determines YES in S60 and proceeds to S66. If not, the controller 100 determines NO and proceeds to S62.

In S62 following NO in S60, the controller 100 determines whether a predetermined time has elapsed since the pressurizing pump 2 was started. The predetermined time may be set at any value appropriately. The predetermined time in S62 may be changed according to the pressure rise “A”, “B”, or “C” in S52, S56, or S58. If the predetermined time has elapsed in S62, the controller 100 determines YES and proceeds to S64. If not, the controller 100 determines NO and returns to S60. The predetermined time having elapsed with the pressurization uncompleted even though the pressurizing pump 2 is operating (NO in S60, YES in S62) means that the leakage from the closing valve 12 is present. Thus, in S64 following YES in S62, the controller 100 determines that the closing valve 12 is abnormal and notifies of the abnormality from the notifier 103. For example, the controller 100 turns on the lamp of the notifier 103.

When the pressurization is completed in S60, the pressure in the vapor passage 71 downstream of the closing valve 12 is greater than the pressure in the vapor passage 71 upstream of the closing valve 12. In S66 following YES in S60, the controller 100 stops the pressurizing pump 2. Further, in S66, the controller 100 brings the open air valve 16 on the open air passage 72 into the closed state. The pressure in the portion on the canister 40 side relative to the closing valve 12 is maintained by the open air valve 16 being brought into the closed state. In S68, the controller 100 sets an adjustment completion flag indicating that the pressure adjustment is completed. Then, the controller 100 ends the pressure adjusting process.

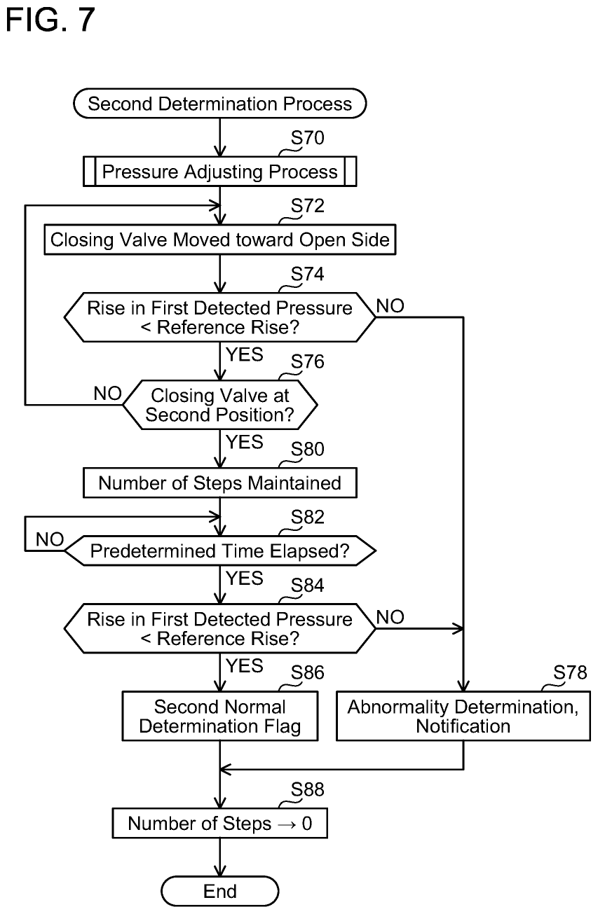

(Second Determination Process; FIG. 7)

Next, the second determination process (see S12 in FIG. 4) will be described in detail. The second determination process follows the first determination process. At the end of the first determination process, the closing valve 12 is at the first position in the closed state. In the second determination process, whether leakage from the closing valve 12 is present or not when the closing valve 12 is at the second position can be determined. FIG. 7 shows a flowchart of the second determination process. As shown in FIG. 7, in S70 of the second determination process, the controller 100 executes a pressure adjusting process. In this pressure adjusting process, the pressure in the vapor passage 71 downstream of the closing valve 12 is adjusted such that it becomes greater than the pressure in the vapor passage 71 upstream of the closing valve 12. Although the pressure adjusting process in the second determination process is substantially the same as the pressure adjusting process in the first determination process (see S36 in FIG. 5, FIG. 6), the pressure rises by the pressurizing pump 2 may be changed appropriately. That is, the pressure rises “A”, “B”, and “C” by the pressurizing pump 2 in S52, S56, and S58 of the pressure adjusting process (see FIG. 6) may be changed appropriately. In the pressure adjusting process of the second determination process, a difference “X” between the pressure in the vapor passage 71 upstream of the closing valve 12 and the pressure in the vapor passage 72 downstream of the closing valve 12 becomes a first difference “X1”. The controller 100 starts the pressurizing pump 2 such that the difference “X” between the pressures upstream and downstream of the closing valve 12 becomes the first difference “X1”.

In S72 of the second determination process, the controller 100 causes the closing valve 12, which is configured to open and close the vapor passage 71, to move toward the open side. More specifically, the controller 100 increases the number of steps of the stepping motor 14, which is configured to actuate the closing valve 12, for example, by one step. When the number of steps of the stepping motor 14 is increased by one step, the closing valve 12 is moved toward the open side by one step, accordingly. In S72, the closing valve 12 has not opened yet and is still in the closed state.

In S74, the controller 100 determines whether a rise in the first detected pressure (detected pressure by the first pressure sensor 31) after the closing valve 12 moved toward the open side is less than a predetermined reference rise. The predetermined reference rise may be set at any value appropriately. If the rise in the first detected pressure is less than the reference rise, the controller 100 determines YES in S74 and proceeds to S76. If not (if the rise in the first detected pressure is equal to or greater than the reference rise), the controller 100 determines NO and proceeds to S78.

The rise in the first detected pressure being equal to or greater than the reference rise means that gas in the vapor passage 71 downstream of the closing valve 12 flows through the closing valve 12 even though the closing valve 12 is in the closed state and the pressure in the fuel tank 30 is thereby raised. In this case, it can be determined that leakage from the closing valve 12 is present. Thus, in S78 following NO in S74, the controller 100 determines that the closing valve 12 is abnormal and notifies of the abnormality from the notifier 103. For example, the controller 100 turns on the lamp of the notifier 103.

In S76 following YES in S74, the controller 100 determines whether the closing valve 12 has reached the second position. The second position of the closing valve 12 is closer to the opened state than the first position set in the first determination process (see FIG. 5). The second position is, for example, a position right before the closing valve 12 transitions to the opened state. If the closing valve 12 has reached the second position, the controller 100 determines YES in S76 and proceeds to S80. If not, the controller 100 determines NO and returns to S72. The controller 100 repeatedly increases the number of steps of the stepping motor 14 until the closing valve 12 reaches the second position. The controller 100 may calculate the second position, for example, from the valve-opening-start position specified in the previous valve-opening-start position specifying process (S24 in FIG. 4).

In S80 following YES in S76, the controller 100 maintains the number of steps of the stepping motor 14 at the number at the time when the closing valve 12 has reached the second position. The closing valve 12 is thereby maintained at the second position. In S82, the controller 100 determines whether a predetermined time has elapsed since the closing valve 12 reached the second position. The predetermined time may be set at any value appropriately. If determining YES in S82, the controller 100 proceeds to S84, while if determining NO, the controller 100 waits.

In S84, the controller 100 determines whether a rise in the first detected pressure (detected pressure by the first pressure sensor 31) after the closing valve 12 reached the second position is less than a predetermined reference rise. The reference rise may be set at any value appropriately. If the rise in the first detected pressure is less than the reference rise, the controller 100 determines YES in S84 and proceeds to S86. If not (if the rise in the first detected pressure is equal to or greater than the reference rise), the controller 100 determines NO and proceeds to S78.

The rise in the first detected pressure being equal to or greater than the reference rise means that gas in the vapor passage 71 downstream of the closing valve 12 flows through the closing valve 12 even though the closing valve 12 is at the second position and the pressure in the fuel tank 30 is thereby raised. In this case, it can be determined that leakage from the closing valve 12 is present. Thus, in S78 following NO in S84, the controller 100 determines that the closing valve 12 is abnormal and notifies of the abnormality from the notifier 103. For example, the controller 100 turns on the lamp of the notifier 103.

On the other hand, the rise in the first detected pressure remaining less than the reference rise even though the predetermined time has elapsed since the closing valve 12 reached the second position (YES in S82, YES in S84) means that there is no leakage from the closing valve 12 when the closing valve 12 is at the second position. Thus, in S86 following YES in S84, the controller 100 sets the second normal determination flag. The second normal determination flag is information indicating that there is no leakage from the closing valve 12 in the second determination process.

In S88 following S86 or S78, the controller 100 brings the number of steps of the stepping motor 14 back to 0 (zero). When the number of steps of the stepping motor 14 is brought back to zero, the closing valve 12 is set at the first position. Then, the controller 100 ends the second determination process.

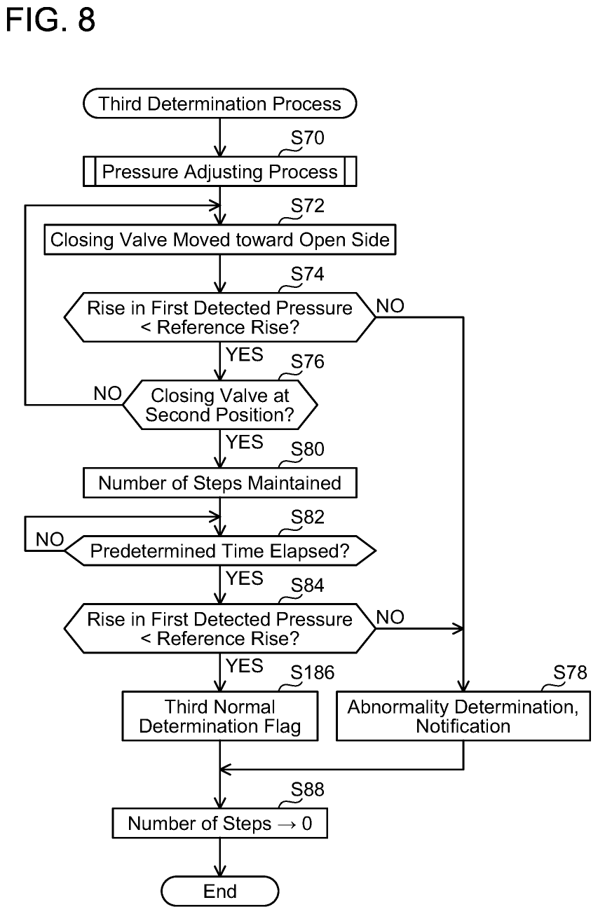

(Third Determination Process; FIG. 8)

Next, the third determination process (see S14 in FIG. 4) will be described. The third determination process follows the second determination process. At the end of the second determination process, the closing valve 12 is set at the first position in the closed state. In the third determination process, as in the second determination process (see FIG. 7), whether leakage from the closing valve 12 is present or not when the closing valve 12 is at the second position can be determined. In the third determination process, however, the difference “X” between the pressure in the vapor passage 71 upstream of the closing valve 12 and the pressure in the vapor passage 71 downstream of the closing valve 12 is smaller than that in the second determination process.

FIG. 8 shows a flowchart of the third determination process. For the description of the third determination process, the same processes as those in the second determination process will not be described and processes different from those in the second determination process will be described. As shown in FIG. 8, in S70 of the third determination process, as in the second determination process, the controller 100 executes a pressure adjusting process. In the pressure adjusting process of the third determination process, the pressure rises “A”, “B”, and “C” by the pressurizing pump 2 in S52, S56, and S58 (see FIG. 6) are smaller than the pressure rises in the second determination process. Thus, when the pressurization by the pressurizing pump 2 is completed, the difference “X” between the pressure in the vapor passage 71 upstream of the closing valve 12 and the pressure in the vapor passage 71 downstream of the closing valve 12 becomes a second difference “X2”. The second difference “X2” is smaller than the first difference “X1”. In the pressure adjusting process (see FIG. 6) of the third determination process, the controller 100 starts the pressurizing pump 2 in S52, S56, or S58 such that the difference “X” between the pressures upstream and downstream of the closing valve 12 becomes the second difference “X2”.

When the difference “X” between the pressure in the vapor passage 71 upstream of the closing valve 12 and the pressure in the vapor passage 71 downstream of the closing valve 12 is set to the second difference “X2” while the closing valve 12 is at the second position in the closed state, gas containing the evaporated fuel may leak from the closing valve 12. That is, the gas in the vapor passage 71 may flow through the closing valve 12. Contrary to this, when the difference “X” is set to the first difference “X1”, which is larger than the second difference “X2”, while the closing valve 12 is at the second position in the closed state (see the pressure adjusting process (S70) in the second determination process (FIG. 7)), the gas containing the evaporated fuel may not leak from the closing valve 12. That is, leakage from the closing valve 12 may differ depending on whether the pressure difference “X” is the larger difference “X1” or the smaller difference “X2”.

As shown in FIG. 8, in S84 of the third determination process, the controller 100 determines whether a rise in the first detected pressure (detected pressure by the first pressure sensor 31) after the closing valve 12 reached the second position is less than a predetermined reference rise. The predetermined reference rise may be set at any value appropriately. If the rise in the first detected pressure is less than the reference rise, the controller 100 determines YES in S84 and proceeds to S186. If not (if the rise in the first detected pressure is equal to or greater than the reference rise), the controller 100 determines NO and proceeds to S78.

The rise in the first detected pressure being equal to or greater than the reference rise means that the gas in the vapor passage 71 downstream of the closing valve 12 flows through the closing valve 12 even though the closing valve 12 is at the second position and the pressure in the fuel tank 30 is thereby raised. In this case, it can be determined that leakage from the closing valve 12 is present. Thus, in S78 following NO in S84, the controller 100 determines that the closing valve 12 is abnormal and notifies of the abnormality from the notifier 103. For example, the controller 100 turns on the lamp of the notifier 103.

On the other hand, the rise in the first detected pressure remaining less than the reference rise even though the predetermined time has elapsed since the closing valve 12 reached the second position (YES in S82, YES in S84) means that there is no leakage from the closing valve 12 when the closing valve 12 is at the second position. Thus, in S186 following YES in S84, the controller 100 sets the third normal determination flag. The third normal determination flag is information indicating that there is no leakage from the closing valve 12 in the third determination process.

As shown in FIG. 4, in the determination process, the controller 100 determines, after the third determination process, that the closing valve 12 is operating normally in S22 if determining that the first to third normal determination flags are stored in the memory 102. To the contrary, the controller 100 determines that the closing valve 12 is operating abnormally in S26 if at least one of the first to third normal determination flags is not stored in the memory 102. Then, the controller 100 executes the valve-opening-start position specifying process in S24.

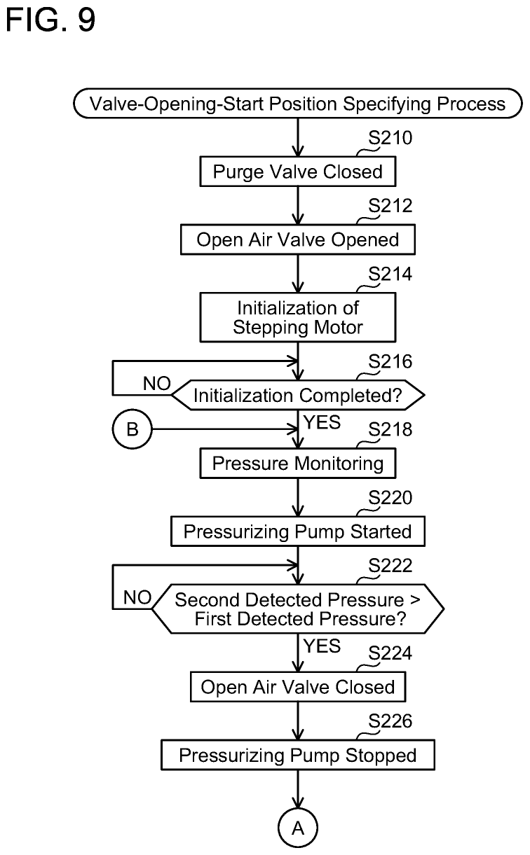

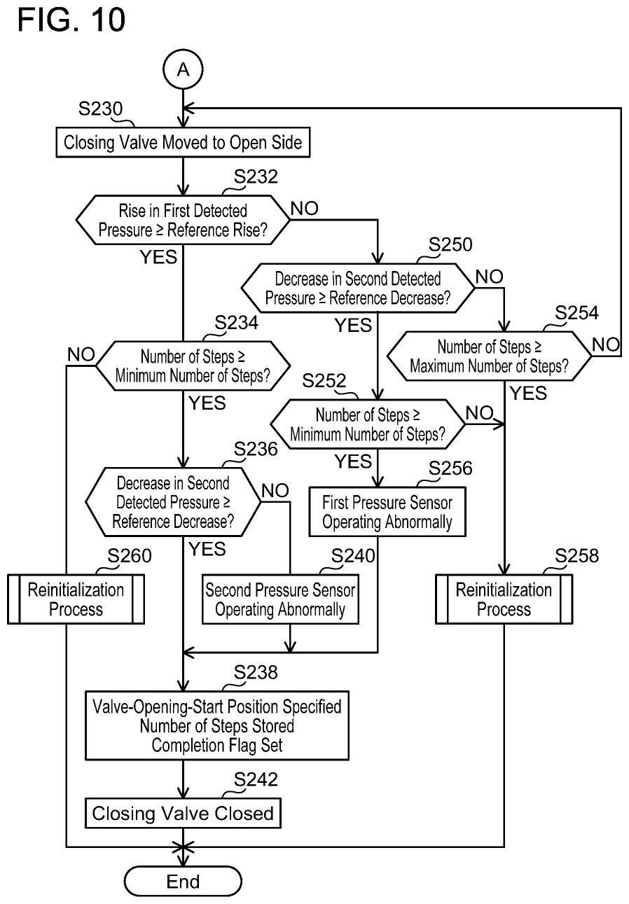

(Valve-Opening-Start Position Specifying Process; FIGS. 9 and 10)

Next, the valve-opening-start position specifying process (see S24 in FIG. 4) in the determination process will be described. The valve-opening-start position specifying process is executed after the third determination process. In the valve-opening-start position specifying process, the valve-opening-start position where the closing valve 12 on the vapor passage 71 transitions from the closed state to the opened state can be specified. FIGS. 9 and 10 show a flowchart of the valve-opening-start position specifying process. The valve-opening-start position specifying process is started, for example, when the IG switch 105 of the vehicle in which the evaporated fuel processing device 1 is mounted is turned on. The IG switch 105 is turned on, for example, when the start button of the engine 92 is pressed by the driver of the vehicle.

As shown in FIG. 9, in S210 of the valve-opening-start position specifying process, the controller 100 brings the purge valve 74 on the purge passage 73 into the closed state. Then, in S212, the controller 100 brings the open air valve 16 on the open air passage 72 into the opened state.

In S214, the controller 100 executes the initialization of the stepping motor 14, which actuates the closing valve 12. The initialization of the stepping motor 14 is a process of setting the initial value of the stepping motor 14 by decreasing the number of steps of the stepping motor 14 (i.e., by rotating the stepping motor 14 in the negative direction). As a result of the initialization of the stepping motor 14, the initial value of the stepping motor 14 is set.

In S216, the controller 100 determines whether the initialization of the stepping motor 14 is completed. Whether the initialization is completed or not is determined, for example, based on whether the number of steps of the stepping motor 14 has been sufficiently decreased to bring the closing valve 12 into the closed state. If the initialization is completed, the controller 100 determines YES in S216 and proceeds to S218. If not, the controller 100 determines NO and waits.

In S218, the controller 100 monitors the pressure detected by the first pressure sensor 31 (i.e., the pressure in the fuel tank 30). The controller 100 also monitors the pressure detected by the second pressure sensor 32 (i.e., the pressure in the open air passage 72). By monitoring the detected pressure by the second pressure sensor 32, the controller 100 indirectly monitors the pressure in the vapor passage 71 downstream of the closing valve 12.

In S220, the controller 100 starts the pressurizing pump 2. When the pressurizing pump 2 is started, the air from the open air is pumped to the canister 40. The gas in the open air passage 72 is thereby pressurized toward the canister 40. Along with this, the gas in the canister 40 is also pressurized toward the purge passage 73 and the vapor passage 71. Since the purge valve 74 on the purge passage 73 is in the closed state, the gas in the purge passage 73 does not flow through the purge valve 74. Further, when the closing valve 12 on the vapor passage 71 is in the closed state, the gas in the vapor passage 71 does not flow through the closing valve 12. When the closing valve 12 is in the opened state, the gas in the vapor passage 71 flows through the closing valve 12.

In S222, the controller 100 determines whether the second detected pressure (detected pressure by the second pressure sensor 32) is higher than the first detected pressure (detected pressure by the first pressure sensor 31). If the second detected pressure is higher than the first detected pressure, the controller 100 determines YES in S222 and proceeds to S224. If not, the controller 100 determines NO and waits. The controller 100 increases the output of the pressurizing pump 2 until the second detected pressure becomes higher than the first detected pressure.

In S224 following YES in S222, the controller 100 brings the open air valve 16 into the closed state. Thereby, the pressure in a space defined by the open air valve 16, the purge valve 74, and the closing valve 12 is maintained. Then, in S226, the controller 100 stops the pressurizing pump 2. When the process of S226 is completed, the controller 100 proceeds to 5230 through “A” (see FIG. 10).

As shown in FIG. 10, in S230, the controller 100 causes the closing valve 12 to move toward the open side. More specifically, the controller 100 increases the number of steps of the stepping motor 14, which actuates the closing valve 12, for example, by one step. When the number of steps of the stepping motor 14 is increased, for example, by one step, the closing valve 12 is moved toward the open side by one step, accordingly. In the course of the number of steps of the stepping motor 14 being increased, the closing valve 12 transitions from the closed state to the opened state at a certain point. That is, the closing valve 12 reaches the valve-opening-start position.

Once the closing valve 12 has reached the valve-opening-start position in the process of S230, the gas in the vapor passage 71 downstream of the closing valve 12 flows through the closing valve 12 into the fuel tank 30. Thereby, the pressure in the fuel tank 30 is raised and the first detected pressure is raised. Further, once the closing valve 12 has reached the valve-opening-start position in the process of S230, the pressure in the vapor passage 71 downstream of the closing valve 12 decreases. Thereby, the pressure in the open air passage 72 decreases and the second detected pressure decreases. On the other hand, when the closing valve 12 is still in the closed state even though it has started to move to the open side, the first detected pressure does not rise and the second detected pressure does not decrease.

In S232, the controller 100 determines, based on the information obtained from the first pressure sensor 31, whether a rise in the first detected pressure is no less than a predetermined reference rise. That is, the controller 100 determines whether a rise in the pressure in the fuel tank 30 is no less than the reference rise. If the rise in the first detected pressure is equal to or greater than the reference rise, the controller 100 determines YES in S232 and proceeds to S234. If not (if the rise in the first detected pressure is less than the reference rise), the controller 100 determines NO and proceeds to S250. The reference rise used in S232 is a pressure rise by which the transition of the closing valve 12 from the closed state to the opened state can be recognized. The reference rise may be set at any value appropriately.

In S234 following YES in S232, the controller 100 determines whether the present number of steps of the stepping motor 14 is no less than a predetermined minimum number of steps. More specifically, the controller 100 determines whether the number of steps of the stepping motor 14 from the initial value after the initialization of the stepping motor 14 to the present number is no less than the minimum number of steps (e.g., four steps). If the present number of steps is equal to or greater than the minimum number of steps, the controller 100 determines YES in S234 and proceeds to S236. If not, the controller 100 determines NO and proceeds to S260. In S260, the controller 100 executes a reinitialization process to be described later.

In S236 following YES in S234, the controller 100 determines, based on the information obtained from the second pressure sensor 32, whether a decrease in the second detected pressure is no less than a predetermined reference decrease. That is, the controller 100 determines whether a decrease in the pressure in the open air passage 72 is no less than the reference decrease. The controller 100 thus indirectly determines whether a decrease in the pressure in the vapor passage 71 downstream of the closing valve 12 is no less than the reference decrease. If the decrease in the second detected pressure is equal to or greater than the reference decrease, the controller 100 determines YES in S236 and proceeds to S238. If not (if the decrease in the second detected pressure is less than the reference decrease), the controller 100 determines NO and proceeds to S240. The reference decrease used in S236 is a pressure decrease by which the transition of the closing valve 12 from the closed state to the opened state can be recognized. The reference decrease may be set at any value appropriately.

In S240 following NO in S236, the controller 100 determines that the second pressure sensor 32 is operating abnormally. If the second pressure sensor 32 is operating normally, the decrease in the second detected pressure is supposed to become equal to or greater than the reference decrease (YES in S236) when the closing valve 12 is brought to the opened state in the process of S230. If the decrease in the second detected pressure does not change as such (NO in S236), it can be determined that the second pressure sensor 32 is operating abnormally. The controller 100 determines that the second pressure sensor 32 is operating abnormally when the second detected pressure does not decrease (NO in S236) even though the first detected pressure rises (YES in S232).

In S238 following YES in S236, the controller 100 specifies the valve-opening-start position of the closing valve 12 based on the present number of steps of the stepping motor 14. More specifically, the controller 100 specifies the present position of the closing valve 12 in accordance with the present number of steps of the stepping motor 14 and specifies that position as the valve-opening-start position. The valve-opening-start position of the closing valve 12 is the position at which the closing valve 12 transitions from the closed state to the opened state. Once the closing valve 12 has reached the valve-opening-start position, the rise in the first detected pressure becomes equal to or greater than the reference rise (YES in S232) and the decrease in the second detected pressure becomes equal to or greater than the reference decrease (YES in S236) if the first pressure sensor 31 and the second pressure sensor 32 are operating normally. The controller 100 specifies the position of the closing valve 12 at such timing as the valve-opening-start position.

Further, in S238, the controller 100 stores the present number of steps of the stepping motor 14 in the memory 102. In a variant, the controller 100 may store the number of steps immediately before the present number of steps (that is, one step before the present number of steps) in the memory 102. The controller 100 may store the number of steps immediately before the closing valve 12 transitions from the closed state to the opened state (that is, immediately before the valve-opening-start position) in the memory 102. In S238, the controller 100 also sets a completion flag indicating that the specification for the valve-opening-start position of the closing valve 12 has been completed and stores the flag in the memory 102.

In S242, the controller 100 causes the closing valve 12 to move toward the closing side to bring the closing valve 12 into the closed state. More specifically, the controller 100 decreases the number of steps of the stepping motor 14. As the number of steps of the stepping motor 14 is decreased, the closing valve 12 moves toward the closing side. When the process of S242 is completed, the controller 100 ends the valve-opening-start position specifying process.

In S250 following NO in S232, the controller 100 determines, based on the information obtained from the second pressure sensor 32, whether a decrease in the second detected pressure is no less than the reference decrease. The process of S250 is the same as the process of S236 which has been described above, and thus detailed description thereon is omitted. The controller 100 proceeds to S252 if determining YES in S250, while it proceeds to S254 if determining NO in S250.

In S252 following YES in S250, the controller 100 determines whether the present number of steps of the stepping motor 14 is no less than the predetermined minimum number of steps. The process of S252 is the same as the process of S234 which has been described above, and thus detailed description thereon is omitted. The controller 100 proceeds to S256 if determining YES in S252, while it proceeds to S258 if determining NO in S252.

In S256 following YES in S252, the controller 100 determines that the first pressure sensor 31 is operating abnormally. If the first pressure sensor 31 is operating normally, the rise in the first detected pressure is supposed to become equal to or greater than the reference rise (YES in S232) when the closing valve 12 is brought into the opened state in S230. If the rise in the first detected pressure does not change so (NO in S232), it can be determined that the first pressure sensor 31 is operating abnormally. The controller 100 determines that the first pressure sensor 31 is operating abnormally when the second detected pressure decreases (YES in S250) without the first detected pressure rising. When the process of S256 is completed, the controller 100 proceeds to S238.

In S254 following NO in S250, the controller 100 determines whether the present number of steps of the stepping motor 14 is no less than a predetermined maximum number of steps. More specifically, the controller 100 determines whether the number of steps of the stepping motor 14 from the initial value after the initialization of the stepping motor 14 to the present number is no less than the maximum number of steps (e.g., twenty steps). If the present number of steps is equal to or greater than the maximum number of steps, the controller 100 determines YES in S254 and proceeds to S258. If not, the controller 100 determines NO and returns to S230. In S258, the controller 100 executes the reinitialization process to be described later.

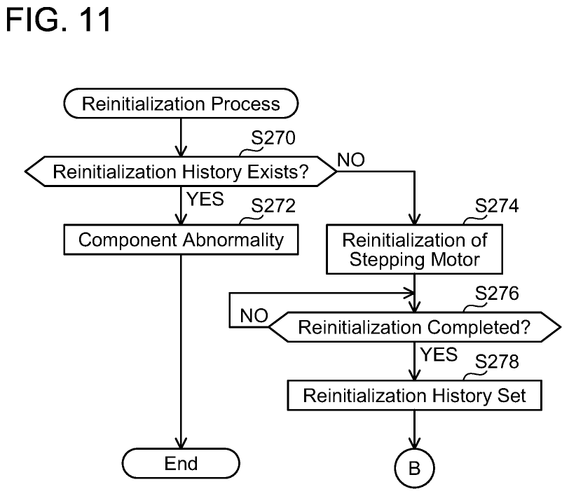

(Reinitialization Process; FIG. 11)

Next, the reinitialization process will be described. FIG. 11 is a flowchart of the reinitialization process. As shown in FIG. 11, in S270 of the reinitialization process, the controller 100 determines whether a reinitialization history is present in the memory 102. The reinitialization history is information indicating that reinitialization of the stepping motor 14 has been executed before. If the reinitialization history is present in the memory 102, the controller 100 determines YES in S270 and proceeds to S272. If the reinitialization history is not present, the controller 100 determines NO and proceeds to S274.

In S272, the controller 100 determines that an abnormality is occurring in a component of the evaporated fuel processing device 1. For example, it determines that an abnormality is occurring in the closing valve 12. Alternatively, it determines that an abnormality is occurring in the first pressure sensor 31 or the second pressure sensor 32. When the process of S272 is completed, the controller 100 ends the reinitialization process as well as the valve-opening-start position specifying process (see FIG. 10).

In S274 following NO in S270, the controller 100 executes reinitialization of the stepping motor 14. When the reinitialization of the stepping motor 14 is executed, the initial value of the stepping motor 14 is set again. Further, when the reinitialization of the stepping motor 14 is executed, the closing valve 12 is moved toward the closing side again into the closed state.

In S276, the controller 100 determines whether the reinitialization of the stepping motor 14 has been completed. If the reinitialization has been completed, the controller 100 determines YES in S276 and proceeds to S278. If not, the controller 100 determines NO and waits.

In S278, the controller 100 sets reinitialization history and stores it in the memory 102. The reinitialization history is information indicating that the reinitialization of the stepping motor 14 has been executed. When the process of S278 is completed, the controller 100 proceeds to “B” and executes the process of S218 in the valve-opening-start position specifying process shown in FIG. 9. The reinitialization process has been described.

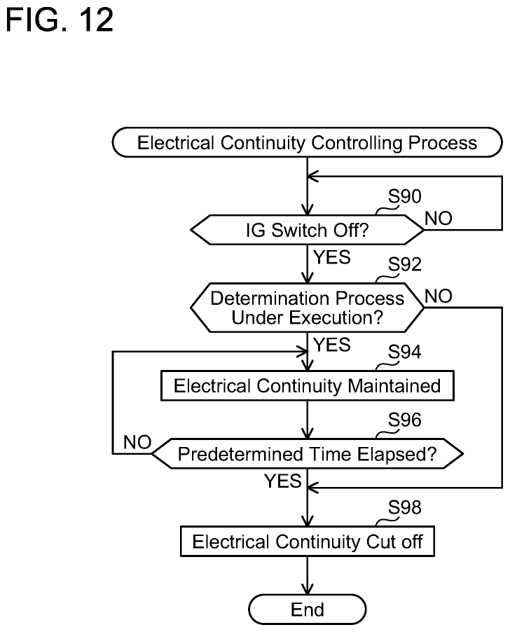

(Electrical Continuity Controlling Process; FIG. 12)

Next, an electrical continuity controlling process executed in the evaporated fuel processing device 1 will be described. The electrical continuity controlling process is executed in parallel with the determination process (see FIG. 4). FIG. 12 shows a flowchart of the electrical continuity controlling process. The electrical continuity controlling process is started, for example, when the IG switch 105 of the vehicle is turned on. As shown in FIG. 12, in S90 of the electrical continuity controlling process, the controller 100 monitors whether the IG switch 105 is turned off or not. If the IG switch 105 is turned off, the controller 100 determines YES in S90 and proceeds to S92. If not, the controller 100 determines NO and waits.

Un S92, the controller 100 determines whether the determination process (see FIG. 4) is in execution. If the determination process is in execution, the controller 100 determines YES in S92 and proceeds to S94. If not, the controller 100 determines NO and proceeds to S98.

In S94 following YES in S92, the controller 100 maintains electrical continuity without cutting it off. Since the electrical continuity is maintained, the determination process can be continued even though the IG switch 105 was turned off (YES in S90). In S96, the controller 100 determines whether a predetermined time has elapsed since it determined YES in S90. The predetermined time may be set at any value appropriately. If the predetermined time has elapsed, the controller 100 determines YES in S96 and proceeds to S98. If not, the controller 100 determines NO and returns to S94. In a variant, the controller 100 may determine whether the voltage of an accessory battery is no less than a predetermined value in S96. The controller 100 may determine whether the fuel is being supplied to the fuel tank 30.

In S98 following YES in S96, the controller 100 cuts off the electrical continuity. When the electrical continuity is cut off, the determination process is forcibly terminated even though it is in execution (YES in S92). Then, the controller 100 ends the electrical continuity controlling process.

The evaporated fuel processing device 1 according to the embodiment has been described above. As apparent from the above description, the evaporated fuel processing device 1 includes: the vapor passage 71 through which the evaporated fuel generated from the fuel in the fuel tank 30 flows; the closing valve 12 configured to open and close the vapor passage 71; and the first pressure sensor 31 configured to detect the pressure in the fuel tank 30. The first pressure sensor 31 can indirectly detect the pressure in the vapor passage 71 upstream of (on the fuel tank 30 side relative to) the closing valve 12 by detecting the pressure in the fuel tank 30. The controller 100 determines whether leakage from the closing valve 12 is present based on the detected pressure by the first pressure sensor 31 that is detected when the difference “X” between the pressure in the vapor passage 71 upstream of the closing valve 12 and the pressure in the vapor passage 71 downstream of the closing valve 12 is the first difference “X1” (see the second determination process in FIG. 7). Further, the controller 100 determines whether leakage from the closing valve 12 is present based on the detected pressure by the first pressure sensor 31 that is detected when the pressure difference “X” is the second difference “X2” (see the third determination process in FIG. 8). The controller 100 determines whether leakage from the closing valve 12 is present based on the second and third determination processes (see the determination process in FIG. 4).

While the closing valve 12 is in the closed state, the evaporated fuel may not leak from the closing valve 12 when the pressure difference “X” is the larger first difference “X1”, whereas the evaporated fuel may leak from the closing valve 12 when the pressure difference “X” is the smaller second difference “X2”. For example, if the seal member 123 of the closing valve 12 has a minor defect, the evaporated fuel may or may not leak from the closing valve 12 depending on whether the difference “X” between the pressures upstream and downstream of the closing valve 12 is the first difference “X1” or the second difference “X2”. In the above configuration, the controller 100 determines whether leakage from the closing valve 12 is present based on the first detected pressure detected when the pressure difference “X” is the first difference “X1” and the first detected pressure detected when the pressure difference “X” is the second difference “X2”. According to this configuration, the presence of leakage from the closing valve 12 can be determined accurately even when the closing valve 12 is in the closed state by determining it using the different pressure differences.

When the closing valve 12 is in the closed state, the closing valve 12 is settable at either one of the first position and the second position that is closer to the opened state than the first position. The controller 100 determines whether leakage is present when the closing valve 12 is at the second position (YES in S76 of FIGS. 7 and 8). In the evaporated fuel processing device 1, the closing valve 12 may need to be switched from the closed state to the opened state quickly, for example, for the evaporated fuel purging process. Thus, the closing valve 12 may be set at the second position close to the valve-opening-start position. According to the above configuration, the presence of leakage from the closing valve 12 can be determined when the closing valve 12 is at the second position close to the valve-opening-start position, and thus this is especially effective for quick switching of the closing valve 12 from the closed state to the opened state.

The closing valve 12 is set at the second position based on the number of steps of the stepping motor 14. In the configuration in which the stepping motor 14 actuates the closing valve 12, it may take long for the closing valve 12 to reach the valve-opening-start position since the closing valve 12 moves step by step in accordance with the number of steps of the stepping motor 14. According to the above configuration in which the closing valve 12 is set at the second position close to the valve-opening-start position for the leakage determination, it is possible to make the closing valve 12 reach the valve-opening-start position quickly after the leakage determination even in the configuration in which the closing valve 12 is actuated by the stepping motor 14.

The controller 100 specifies the valve-opening-start position where the closing valve 12 transitions from the closed state to the opened state based on the first detected pressure. According to this configuration, it is possible to perform the determination on leakage from the closing valve 12 and the specifying of the valve-opening-start position of the closing valve 12 successively. The valve-opening-start position can be specified quickly.

While the embodiment has been described above, specific aspects are not limited to the above embodiment. In the following description, elements that are identical to those described in the foregoing description will be given the same reference signs and description thereof will be omitted.

In the above embodiment, the controller 100 determines whether leakage from the closing valve 12 is present based on the first detected pressure (detected pressure by the first pressure sensor 31). In a variant, the controller 100 may determine whether leakage from the closing valve 12 is present based on the second detected pressure (detected pressure by the second pressure sensor 32).

(First Variant)

In the above embodiment, the controller 100 determines whether the rise in the first detected pressure is less than the reference rise in S38 of the first determination process (see FIG. 5). In a first variant, the controller 100 may determine whether a decrease in the second detected pressure (detected pressure by the second pressure sensor 32) is less than a reference decrease in S38. The reference decrease may be set at any value appropriately. If the decrease in the second detected pressure is less than the reference decrease, the controller 100 determines YES in S38 and proceeds to S40. If not (the decrease in the second detected pressure is equal to or greater than the reference decrease), the controller 100 determines NO and proceeds to S46.

The decrease in the second detected pressure being equal to or greater than the reference decrease means that the gas in the vapor passage 71 downstream of the closing valve 12 flows through the closing valve 12 even though the closing valve 12 is at the first position and the pressure in the portion on the canister 40 side relative to the closing valve 12 decreases. In this case, it can be determined that leakage from the closing valve 12 is present. Thus, in S46 following NO in S38, the controller 100 determines the abnormality of the closing valve 12 and notifies of the abnormality from the notifier 103. For example, the controller 100 turns on the lamp of the notifier 103.

(Second Variant) In a second variant, in S38 of the first determination process (see FIG. 5), the controller 100 may determine whether the decrease in the second detected pressure is less than a predetermined reference decrease as well as determine whether the rise in the first detected pressure is less than the reference rise. If the rise in the first detected pressure is less than the reference pressure and the decrease in the second detected pressure is less than the predetermined reference decrease, the controller 100 determines YES in S38 and proceeds to S40. If not (if the rise in the first detected pressure is equal to or greater than the reference rise or if the decrease in the second detected pressure is equal to or greater than the reference decrease), the controller 100 determines NO and proceeds to S46.

(Third Variant)

In a third variant, in S74 and S84 of the second determination process (see FIG. 7), the controller 100 may determine whether a decrease in the second detected pressure (i.e., the detected pressure by the second pressure sensor 32) is less than a predetermined reference decrease. If the decrease in the second detected pressure is less than the predetermined reference pressure, the controller 100 determines YES in S74 and S84.

(Fourth Variant)

In a fourth variant, in S74 and S84 of the second determination process (see FIG. 7) and the third determination process (see FIG. 8), the controller 100 may determine whether a decrease in the second detected pressure is less than a predetermined reference decrease as well as determine whether the rise in the first detected pressure is less than the reference rise. If the rise in the first detected pressure is less than the reference rise and the decrease in the second detected pressure is less than the predetermined reference decrease, the controller 100 determines YES in S74 and S84. If not (if the rise in the first detected pressure is equal to or greater than the reference rise or if the decrease in the second detected pressure is equal to or greater than the reference decrease), the controller 100 determines NO.

(Fifth Variant) In the embodiment described above, the first pressure sensor 31 is disposed at the fuel tank 30, however, the first pressure sensor 31 may be disposed on the vapor passage 71 in a fifth variant. The first pressure sensor 31 may be disposed on the portion of the vapor passage 71 upstream of the closing valve 12. The first pressure sensor 31 may directly detect the pressure in the part of the vapor passage 71 upstream of the closing valve 12.

(Sixth Variant) In the embodiment described above, the second pressure sensor 32 is disposed on the open air passage 72, however, the second pressure sensor 32 may be disposed on the vapor passage 71 in a sixth variant. The second pressure sensor 32 may be disposed on the part of the vapor passage 71 downstream of the closing valve 12. The second pressure sensor 32 may directly detect the pressure in the part of the vapor passage 71 downstream of the closing valve 12.

(Seventh Variant) In a seventh variant, the controller 100 may execute the pressure adjusting process (see FIG. 6) in the valve-opening-start position specifying process (see FIGS. 9 and 10).

(Eighth Variant) In an eighth variant, the controller 100 may execute the valve-opening-start position specifying process before the second determination process. According to this configuration, whether leakage from the closing valve 12 is present can be determined using a difference between the pressures upstream and downstream of the closing valve 12 that is set in the valve-opening-start position specifying process.

(Ninth Variant) In a ninth variant, the controller 100 may delete the first to third normal determination flags from the memory 102 after the valve-opening-start position specifying process (see S24 in FIG. 4) has been ended and thus the determination process has been ended.

What is claimed is:

1. An evaporated fuel processing device comprising:
a fuel tank;
a vapor passage through which evaporated fuel generated from fuel in the fuel tank flows;
a closing valve configured to open and close the vapor passage;
a first pressure sensor configured to detect a pressure in the vapor passage upstream of the closing valve directly or indirectly; and/or a second pressure sensor configured to detect a pressure in the vapor passage downstream of the closing valve directly or indirectly; and
a controller,
wherein
when the closing valve is in a closed state, the controller determines presence of leakage from the closing valve based on:
the pressure detected by the first pressure sensor and/or the pressure detected by the second pressure sensor detected when a difference between the pressure in the vapor passage upstream of the closing valve and the pressure in the vapor passage downstream of the closing valve is a first difference; and
the pressure detected by the first pressure sensor and/or the pressure detected by the second pressure sensor detected when the difference is a second difference different from the first difference.

2. The evaporated fuel processing device according to claim 1, wherein
when the closing valve is in the closed state, the closing valve is settable to either one of a first position and a second position that is closer to an opened state of the closing valve than the first position, and
the controller determines the presence of the leakage when the closing valve is at the second position.

3. The evaporated fuel processing device according to claim 2, further comprising a stepping motor configured to actuate the closing valve,
wherein the closing valve is set to the second position based on a number of steps by which the stepping motor has rotated.

4. The evaporated fuel processing device according to claim 1, wherein
the controller specifies a valve-opening-start position of the closing valve based on the pressure detected by the first pressure sensor and/or the pressure detected by the second pressure sensor, wherein the valve-opening-start position is a position where the closing valve transitions from the closed state to an opened state.
